(19) United States
(12) Patent Application Publication
(10) Pub. No.: US 2025/0054000 A1
(43) Pub. Date: Feb. 13, 2025

(54) SYSTEM AND METHOD FOR DETERMINING EFFECT OF PROMOTERS AND DETRACTORS ON NET CUSTOMER ACQUISITION

(71) Applicant: DRSYA TECHNOLOGIES PRIVATE LIMITED, Bangalore (IN)

(72) Inventors: Ashish MUNGI, Bangalore (IN); Ajit RAO, Bangalore (IN); Seshagiri GUDIPUDI, Bangalore (IN)

(21) Appl. No.: 18/795,238

(22) Filed: Aug. 6, 2024

Related U.S. Application Data
(60) Provisional application No. 63/518,106, filed on Aug. 8, 2023.

(51) Int. Cl. G06Q 30/0201

(52) U.S. Cl. CPC G06Q 30/0201

(57) ABSTRACT

A system for determining effect of promoters and detractors on net customer acquisition, the system comprising of, a data acquisition module configured to conduct an enhanced net promoter score survey for capturing a referral disposition by receiving an input related to recommendations or positive feedback given to others, positive feedback received from others, negative feedback given to others, and negative feedback or communication received from others by a respondent and a data processing module connected with the data acquisition module, the data processing module configured to determining effect of promoters and detractors on net customer acquisition by processing the referral disposition.

### FIELD OF THE INVENTION

Embodiments of the invention relate generally to data analysis system and method. More specifically, embodiments of the invention provide a system and method for determining the effect of promoters and detractors on net customer acquisition is disclosed for predicting acquisition or churn of customers.

### DESCRIPTION OF THE RELATED ART

Net Promoter Score (NPS) is a metric used to measure customer satisfaction and loyalty. The net promoter score is calculated based on a single question that asks customers how likely they are to recommend a company's products or services to others on a scale from 0 to 10. Customers who give a score of 9 or 10 are considered promoters, those who give a score of 7 or 8 are considered passive, and those who give a score of 6 or below are considered detractors.

The net promoter score is then calculated by subtracting the percentage of detractors from the percentage of promoters. The score can range from −100 (if everyone is a detractor) to +100 (if everyone is a promoter). A high net promoter score is generally considered a good indicator of customer loyalty and satisfaction.

The net promoter score is important for several reasons. Firstly, the net promoter score serves as a valuable indicator of customer loyalty and satisfaction. Hence, net promoter score may be considered a lead indicator of business performance. By measuring how likely customers are to recommend a company's products or services, net promoter score provides insights into the level of trust and satisfaction in the customers minds. Promoters, who give high scores, are more likely to become repeat customers and recommend the company and its products to others, contributing to organic growth and positive word-of-mouth marketing. Secondly, net promoter score helps companies track their progress over time. By regularly measuring and monitoring net promoter score, businesses can identify trends, patterns, and areas for improvement. Further the net promoter score provides a quantitative benchmark for assessing the impact of customer-centric initiatives and the effectiveness of strategies aimed at enhancing customer satisfaction. Finally, the net promoter score can be used to compare performance against industry competitors. By benchmarking against industry standards, companies can gain a better understanding of their relative position and identify opportunities for differentiation and improvement. Overall, net promoter score is a powerful tool that enables businesses to prioritize actions that drive customer satisfaction, customer growth, and build long-term success.

Conventionally, determining the net promoter score involves a survey-based approach. The process typically begins with the administration of surveys to customers. These surveys usually contain a single question, commonly asked through online platforms, phone, email or in-person. The question posed to customers is along the lines of, “how likely are you to recommend [company/product/service] to a friend or colleague?”. Customers are then asked to rate their likelihood of recommendation on a scale typically ranging from 0 to 10. Based on the survey responses, customers are categorized into three groups: promoters, passives, and detractors. Promoters are customers who give a rating of 9 or 10, indicating a high likelihood of recommendation. Passives are customers who give a rating of 7 or 8, reflecting a neutral stance or satisfaction without strong advocacy. Detractors are customers who give a rating of 0 to 6, indicating a low likelihood of recommendation and potential dissatisfaction.

Further, the net promoter score is calculated by subtracting the percentage of detractors from the percentage of promoters. The resulting score can range from −100 to +100. A higher score indicates a larger proportion of promoters compared to detractors and is generally seen as a positive indicator of customer loyalty and satisfaction.

Once the net promoter score is calculated, businesses analyze the results and use them as a basis for decision-making. They may segment customers by demographic or behavioral characteristics to gain further insights. The net promoter score can be tracked over time to monitor changes in customer sentiment and identify areas for improvement. Companies often follow up with further research or qualitative feedback to understand the reasons behind customer ratings and take appropriate actions to address any issues raised.

The effect of promoters and detractors on net customer acquisition is determined by analyzing the impact of their actions on the growth and expansion of a customer base. Promoters, who are highly likely to recommend a company or product to others, can have a positive effect on net customer acquisition. They act as brand advocates, spreading positive word-of-mouth and referring new customers, which can contribute to organic growth and acquisition.

On the other hand, detractors, who are unlikely to recommend a company or product, can have a negative effect on net customer acquisition. Their negative experiences or dissatisfaction may lead to customer churn, where existing customers stop doing business with the company. Detractors may also share their negative experiences with others, potentially deterring new customers from engaging with the company. Generally, understanding the effect of promoters and detractors on net customer acquisition helps companies identify areas for improvement, optimize customer experiences, and implement strategies to increase customer advocacy, ultimately driving sustainable business growth and profits.

Several systems and methods are available in the market for determining the effect of promoters and detractors on business outcomes, however the conventional system has some inherent drawbacks. The conventional system and method of determining the effect of promoters and detractors on net customer acquisition has a few drawbacks. One limitation is the lack of granularity in the relevant business metrics at a customer level, due to which it is difficult to correlate an individual customer's NPS rating and that customer's effect on net customer acquisition (i.e., customer addition or churn). By grouping customers into broad categories of promoters and detractors, the method overlooks the variations within each group. The customers may have different levels of advocacy or dissatisfaction, which can have varying impacts on net customer acquisition. Further, failing to consider these nuances may lead to a simplified understanding of customer behavior and acquisition dynamics.

Therefore, due to the aforementioned drawbacks there is a need of a robust system and method for determining effect of promoters and detractors on net customer acquisition.

### SUMMARY

A system and method are disclosed for determining the effect of promoters and detractors on net customer acquisition.

In a preferred embodiment, the system comprise of one or more hardware processors, a memory coupled to the one or more hardware processors, wherein the memory comprise a plurality of modules in the form of programmable instructions executable by the one or more hardware processors, and wherein the plurality of modules comprise, a data acquisition module that is configured to conduct an enhanced net promoter score survey for capturing a referral disposition of a respondent by receiving an input related to recommendations or positive feedback given to others, positive feedback received from others, negative feedback given to others, the number of people to whom such negative feedback was given and negative feedback or communication received from others by a respondent. The enhanced net promoter score survey comprises of a set of questions for the respondent. The data acquisition module transfers the response from the respondent to a data processing module. The data processing module is configured to convert a response received from the enhanced net promoter score survey to compute the impact of promoters and detractors on the net customer acquisition. First, from a response, the data processing module assesses the NPS rating provided by an individual respondent to classify the individual respondent into one of the categories of promoters, passives, or detractors, and calculates the net promoter score (NPS) by subtracting the percentage of detractors from the percentage of promoters. Further, the data processing module assesses a referral disposition index to describe a respondent disposition to positively refer and influence a purchase or negatively refer and discourage the purchase of a product, and evaluates a referral impact by multiplying the percentage of respondents who positively referred the product to others with the percentage of respondents who received a positive reference of the product from others. The data processing module calculates the number of referrals per customer acquisition as the inverse of the referral impact. The referral impact is multiplied with the percentage of promoters who positively referred the product to others for obtaining a referral impact of promoters. The data processing module calculates the number of promoter referrals per customer acquisition as the inverse of the referral impact of promoters. Further the data processing module is configured to determine an average number of people discouraged by dividing the total number of people who were discouraged or received a negative reference of the product from the respondents by the total number of respondents and calculate an impact of discouragement by multiplying the percentage of respondents who discouraged others from purchasing the product with the percentage of respondents who received negative references of the product from others multiplied by the average number of people discouraged. The data processing module calculates the number of discouragements per customer churn as the inverse of the discouragement impact. The impact of discouragement is multiplied by the percentage of detractors who negatively referred the product to others for obtaining a measure of a discouragement impact of detractors. The data processing module calculates the number of detractor discouragements per customer churn as the inverse of the discouragement impact of detractors. Furthermore, the data processing module is configured to compute a net addition to a customer base by dividing the total number of promoters by the number of promoter referrals per customer acquisition and then subtracting the total number of detractors divided by the number of detractor discouragements per customer churn. The net addition to the customer base is divided by the total number of respondents to determine the net addition as a percentage of the existing customer base. Additionally, as an optional step if weighted averages need to be computed across customer groups, the data processing module is configured to determine the net addition of each customer group by their assigned weights and adding them together to obtain a net addition aggregate and divide the net addition aggregate by the total number of respondents for obtaining net customer addition aggregate in terms of percentage of the existing customer base.

In another preferred embodiment, a method for determining the effect of promoters and detractors on net customer acquisition is disclosed. The method comprise conducting an enhanced net promoter score survey for capturing a referral disposition of a respondent by receiving an input related to recommendations or positive feedback given to others, positive feedback received from others, negative feedback given to others, the number of people to whom such negative feedback was given and negative feedback or communication received from others by a respondent, converting a response received from the enhanced net promoter score survey to compute an impact of promoters and detractors on the net customer acquisition, assessing the NPS rating provided by an individual respondent to classify the individual respondent into one of the categories of promoters, passives or detractors, and calculates the net promoter score (NPS) by subtracting the percentage of detractors from the percentage of promoters, assessing a referral disposition index to describe a respondent disposition to positively refer and influence a purchase or negatively refer and discourage the purchase of a product, evaluating a referral impact by multiplying the percentage of respondents who positively referred the product to others with the percentage of respondents who received a positive reference of the product from others, calculating the number of referrals per customer acquisition as the inverse of the referral impact, quantifying a referral impact of promoters by multiplying the referral impact with the percentage of promoters who positively referred the product to others, calculating the number of promoter referrals per customer acquisition as the inverse of the referral impact of promoters, determining an average number of people discouraged by dividing the total number of people who were discouraged or received a negative reference of the product from the respondents by the total number of respondents, calculating an impact of discouragement by multiplying the percentage of respondents who discouraged others from purchasing the product with the percentage of respondents who received negative references of the product from others multiplied by the average number of customers discouraged, measuring a discouragement impact of detractors by multiplying the impact of discouragement with the percentage of detractors who negatively referred the product to others, calculating the number of detractor discouragements per customer churn as the inverse of the discouragement impact of detractors, computing a net addition to a customer base by dividing the total number of promoters by the number of promoter referrals per customer acquisition and then subtracting the total number of detractors divided by the number of detractor discouragements per customer churn, calculating net addition as a percentage of the existing customer base by dividing the net addition to customer base with the total number of respondents, and additionally as an optional step if weighted averages need to be computed across customer groups, determining the net addition of each customer group by their assigned weights and adding them together to obtain a net addition aggregate and dividing the net addition aggregate by the total number of respondents for obtaining net customer addition aggregate in terms of percentage of the existing customer base.

### BRIEF DESCRIPTION OF THE DRAWING

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of illustrating internal and external components of an embodiment of a system in which embodiments described herein may be implemented in accordance with the present disclosure.

FIG. 2A and FIG. 2B depicts a flow diagram describing an embodiment of a method for determining the effect of promoters and detractors on net customer acquisition in accordance with the present disclosure.

FIG. 3 depicts a flow chart of a method for determination of respondent type based on response level score in accordance with the present disclosure.

FIG. 4 depicts a workflow diagram describing the processing of the enhanced survey responses for respondent type promoter in accordance with the present disclosure.

FIG. 5 depicts a workflow diagram describing the processing of the enhanced survey responses for respondent type passive in accordance with the present disclosure.

FIG. 6 depicts a workflow diagram describing the processing of the enhanced survey responses for respondent type detractor in accordance with the present disclosure.

FIG. 7 depicts a Venn diagram of positive referral disposition index used in accordance with the present disclosure.

FIG. 8 depicts a Venn diagram of negative referral disposition index used in accordance with the present disclosure.

FIG. 9 depicts a Venn diagram describing computation of promoters who have positively referred and detractors who have discouraged in accordance with the present disclosure.

FIG. 10 depicts a Venn diagram describing computation of referral impact of promoters in accordance with the present disclosure.

FIG. 11 depicts a Venn diagram describing computation of discouragement impact of detractors in accordance with the present disclosure.

FIG. 12 depicts a workflow diagram describing an embodiment of a method for determining the effect of promoters and detractors on net customer acquisition in accordance with the present disclosure.

FIG. 13 depicts a workflow diagram describing an embodiment of a method for calculating the net addition aggregate to an existing customer base using weighted averages for different customer groups in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a system and a method for determining effect of promoters and detractors on net customer acquisition. The system comprise of one or more hardware processors, a memory coupled to the one or more hardware processors, wherein the memory comprise a plurality of modules in the form of programmable instructions executable by the one or more hardware processors, and wherein the plurality of modules comprise a data acquisition module that is configured to conduct an enhanced net promoter score survey for capturing a referral disposition of a respondent by receiving an input related to recommendations or positive feedback given to others, positive feedback received from others, negative feedback given to others, the number of people to whom such negative feedback was given and negative feedback or communication received from others by a respondent. The enhanced net promoter score survey comprises of a set of questions for the respondent. The data acquisition module transfers the response from the respondent to a data processing module. The data processing module is configured to convert a response received from the enhanced net promoter score survey to compute the impact of promoters and detractors on the net customer acquisition. First, from a response, the data processing module assesses the NPS rating provided by an individual respondent to classify the individual respondent into one of the categories of promoters, passives, or detractors, and calculates the net promoter score (NPS) by subtracting the percentage of detractors from the percentage of promoters. Further, the data processing module assesses a referral disposition index to describe a respondent disposition to positively refer and influence a purchase or negatively refer and discourage the purchase of a product, and evaluates a referral impact by multiplying the percentage of respondents who positively referred the product to others with the percentage of respondents who received a positive reference of the product from others. The data processing module calculates the number of referrals per customer acquisition as the inverse of the referral impact. The referral impact is multiplied with the percentage of promoters who positively referred the product to others for obtaining a referral impact of promoters. The data processing module calculates the number of promoter referrals per customer acquisition as the inverse of the referral impact of promoters. Further the data processing module is configured to determine an average number of people discouraged by dividing the total number of people who were discouraged or received a negative reference of the product from the respondents by the total number of respondents and calculate an impact of discouragement by multiplying the percentage of respondents who discouraged others from purchasing the product with the percentage of respondents who received negative references of the product from others multiplied by the average number of people discouraged. The data processing module calculates the number of discouragements per customer churn as the inverse of the discouragement impact. The impact of discouragement is multiplied by the percentage of detractors who negatively referred the product to others for obtaining a measure of a discouragement impact of detractors. The data processing module calculates the number of detractor discouragements per customer churn as the inverse of the discouragement impact of detractors. Furthermore, the data processing module is configured to compute a net addition to a customer base by dividing the total number of promoters by the number of promoter referrals per customer acquisition and then subtracting the total number of detractors divided by the number of detractor discouragements per customer churn. The net addition to the customer base is divided by the total number of respondents to determine the net addition as a percentage of the existing customer base. Additionally, as an optional step if weighted averages need to be computed across customer groups, the data processing module is configured to determine the net addition of each customer group by their assigned weights and adding them together to obtain a net addition aggregate and divide the net addition aggregate by the total number of respondents for obtaining net customer addition aggregate in terms of percentage of the existing customer base.

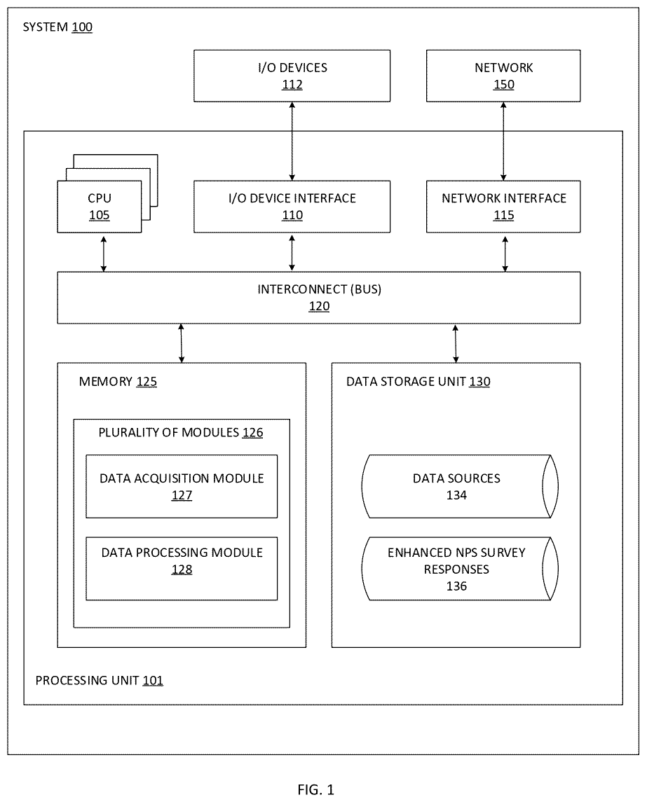

FIG. 1 depicts a block diagram of the system 100 for determining effect of promoters and detractors on net customer acquisition, in accordance with exemplary embodiment. In various embodiments, the system 100 comprises one or more processing units 101. Each processing unit 101 includes a memory 125, data storage 130, an interconnect (e.g., BUS) 120, one or more processors (e.g., CPUs) 105, an I/O device interface 110, I/O devices 112, and a network interface 115.

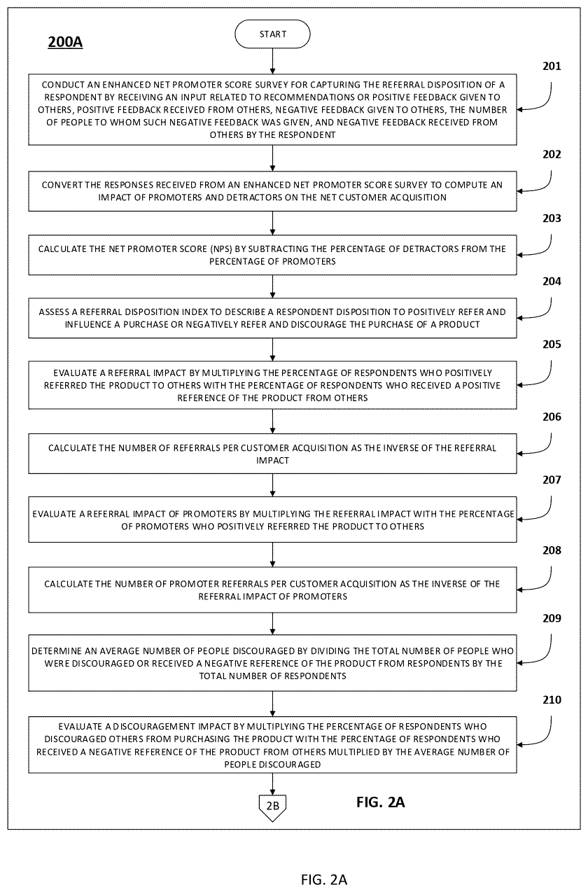

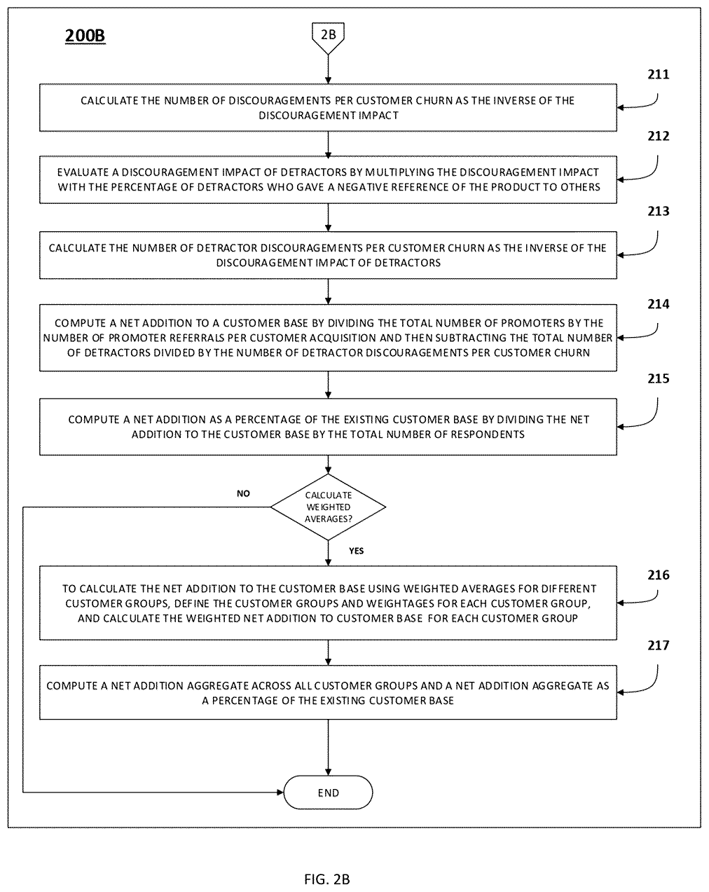

Each processor 105 can be communicatively coupled to the memory 125 or storage 130. Each processor 105 can retrieve and execute programming instructions stored in memory 125 or storage 130. In some embodiments, each processor 105 can execute methods as shown and described hereinafter with reference to FIG. 2 through FIG. 17, or equivalents thereof. The interconnect 120 is used to move data, such as programming instructions, between the CPU 105, I/O device interface 110, storage 130, network interface 115, and memory 125. The interconnect (bus) 120 can be implemented using one or more buses. The processors 105 can be a single CPU, multiple CPUs, or a single CPU having multiple processing cores in various embodiments. In some embodiments, a processor 105 can be a digital signal processor (DSP). Memory 125 is generally included to be representative of a random-access memory (e.g., static random-access memory (SRAM), dynamic random-access memory (DRAM), or Flash). The storage 130 is generally included to be representative of a non-volatile memory, such as a hard disk drive, solid state device (SSD), removable memory cards, optical storage, or flash memory devices. In an alternative embodiment, the storage 130 can be replaced by storage area-network (SAN) devices, the cloud, or other devices connected to the processing unit 101 via the I/O device interface 110 or a communication network 150 via the network interface 115.

The network 150 can be implemented by any number of any suitable communications media (e.g., wide area network (WAN), local area network (LAN), Internet, Intranet, etc.). In certain embodiments, the network 150 can be implemented within a cloud computing environment or using one or more cloud computing services. In some embodiments, the network interface 115 communicates with both physical and virtual networks.

The processing unit 101 and the I/O Devices 112 can be local to each other, and communicate via any appropriate local communication medium (e.g., local area network (LAN), hardwire, wireless link, Intranet, etc.) or they can be physically separated and communicate over a virtual network. In some embodiments, the I/O devices 112 can include a display unit capable of presenting information (e.g., a survey or a set of questions) to a user and receiving one or more inputs (e.g., a survey response or a set of answers) from a user.

In some embodiments, the memory 125 stores a plurality of modules 126 including a data acquisition module 127 and a data processing module 128 while the storage 130 stores data sources 134 and enhanced NPS survey responses 136. However, in various embodiments, the plurality of modules 126 including a data acquisition module 127 and a data processing module 128, the data sources 134, and the enhanced NPS survey responses 136 are stored partially in memory 125 and partially in storage 130, or they are stored entirely in memory 125 or entirely in storage 130, or they are accessed over a network 150 via the network interface 115.

The data acquisition module 127 and data processing module 128 can store processor executable instructions for various methods such as the methods shown and described hereinafter with respect to FIG. 2 through FIG. 17 or the equivalents thereof. In some embodiments, the data sources 134 can comprise documents containing tabular data such as, but not limited to, Portable Document Format (PDF), Word, Excel, PowerPoint, Open Document Format, Google Documents, or other document files. The data sources 134 can contain media such as video files, audio files, images and animations in various file formats such as, but not limited to, MP4, MOV, MP3, WAV, JPG, PNG, GIF, etc. The data sources 134 can further contain web content such as, but not limited to, hypertext markup language (HTML) web content, extensible markup language (XML) web content, or other web content. The enhanced NPS survey responses 136 can comprise both actual responses received through the surveys, computed data fields and data indices in various embodiments. In some cases, the enhanced NPS survey responses 136 are generated by one or more processors 105 evaluating one or more data sources 134 according to data processing module 128 instructions.

The memory 125 comprises a plurality of modules 126 in the form of programmable instructions executable by the one or more hardware processors 105. The plurality of modules 126 comprise a data acquisition module 127 and a data processing module 128. The data acquisition module 127 is configured to conduct an enhanced net promoter score survey for capturing a referral disposition of a respondent by receiving an input related to recommendations or positive feedback given to others, positive feedback received from others, negative feedback given to others, the number of people to whom such negative feedback was given and negative feedback or communication received from others by a respondent. The data acquisition module 127 transfers the response from the respondent to a data processing module 128. The data processing module 128 is configured to convert a response received from the enhanced net promoter score survey to compute the impact of promoters and detractors on the net customer acquisition. First, from a response, the data processing module 128 assesses the NPS rating provided by an individual respondent to classify the individual respondent into one of the categories of promoters, passives, or detractors, and calculates the net promoter score (NPS) by subtracting the percentage of detractors from the percentage of promoters. Further, the data processing module 128 assesses a referral disposition index to describe a respondent disposition to positively refer and influence a purchase or negatively refer and discourage the purchase of a product, and evaluates a referral impact by multiplying the percentage of respondents who positively referred the product to others with the percentage of respondents who received a positive reference of the product from others. The data processing module 128 calculates the number of referrals per customer acquisition as the inverse of the referral impact. The referral impact is multiplied with the percentage of promoters who positively referred the product to others for obtaining a referral impact of promoters. The data processing module 128 calculates the number of promoter referrals per customer acquisition as the inverse of the referral impact of promoters. Further the data processing module 128 is configured to determine an average number of people discouraged by dividing the total number of people who were discouraged or received a negative reference of the product from the respondents by the total number of respondents and calculate an impact of discouragement by multiplying the percentage of respondents who discouraged others from purchasing the product with the percentage of respondents who received negative references of the product from others multiplied by the average number of people discouraged. The data processing module 128 calculates the number of discouragements per customer churn as the inverse of the discouragement impact. The impact of discouragement is multiplied by the percentage of detractors who negatively referred the product to others for obtaining a measure of a discouragement impact of detractors. The data processing module 128 calculates the number of detractor discouragements per customer churn as the inverse of the discouragement impact of detractors. Furthermore, the data processing module 128 is configured to compute a net addition to a customer base by dividing the total number of promoters by the number of promoter referrals per customer acquisition and then subtracting the total number of detractors divided by the number of detractor discouragements per customer churn. The net addition to the customer base is divided by the total number of respondents to determine the net addition as a percentage of the existing customer base. Additionally, as an optional step if weighted averages need to be computed across customer groups, the data processing module 128 is configured to determine the net addition of each customer group by their assigned weights and adding them together to obtain a net addition aggregate and divide the net addition aggregate by the total number of respondents for obtaining net customer addition aggregate in terms of percentage of the existing customer base.

The data acquisition module 127 is a software or hardware component that is configured to collect and capture data from various sources and is responsible for capturing survey responses and related information from respondents participating in an enhanced net promoter score survey. The data acquisition module 127 receives inputs from survey respondents, which may include recommendations or positive feedback given to others, positive feedback received from others, negative feedback given to others, the number of people to whom such negative feedback was given and negative feedback or communication received from others by a respondent. It is configured to process and record this data for further analysis and evaluation. The data acquisition module 127 can be implemented using programming languages, databases, and other relevant technologies and provides an interface or mechanism for respondents to input the net promoter score survey responses and ensures that the collected data is organized, stored, and made available for subsequent analysis and reporting.

The data processing module 128 refers to a physical processor that is configured to perform the computational tasks and calculations and is capable of executing calculations and computations and may include integrated circuits (ICs). Further the data processing module 128 is responsible for receiving the data acquired from the data acquisition module 127, performing the required computations using the appropriate algorithms or logic circuits, and generating the desired outputs or results and may also include memory elements for storing intermediate data and results during the processing.

Exemplary embodiments of the hardware processors 105 may include, but are not limited to, desktop computer systems, workstations, laptops, notebooks, tablets, servers, client devices, network devices, network terminals, thin clients, thick clients, kiosks, mobile communication devices (e.g., smartphones), multiprocessor systems, microprocessor-based systems, minicomputer systems, mainframe computer systems, smart devices, and/or Internet of Things (IoT) devices. The hardware processors 105 are capable of operating within various computing environments, including local computing environments, networked computing environments, containerized computing environments comprising one or more pods or clusters of containers, and/or distributed cloud computing environments. These environments may include any of the systems or devices described herein, as well as additional computing devices or systems known or used by a person of ordinary skill in the art.

Another exemplary embodiment of the system 100 also includes one or more input/output (I/O) interfaces 110 to facilitate the exchange of data with external devices that can be connected to the system. The I/O interface 110 enables connectivity with one or more external devices, including smart devices, Internet of Things (IoT) devices, camera systems, sensor devices, keyboards, computer mice, touch screens, virtual keyboards, touchpads, pointing devices, and other human interface devices. The external devices may also comprise portable computer-readable storage media, such as thumb drives, portable optical or magnetic disks, and memory cards. The I/O interface 110 establishes a connection with a human-readable display, which serves as a means to present data to a user. The human-readable display can take the form of computer monitors, screens, or an integrated touch screen, such as the built-in display of a tablet computer. In particular, the human-readable display can be utilized to display data through a graphical user interface (GUI).

Another exemplary embodiment of the system 100 also contemplates the interconnection of multiple computing systems via a computer network 150. The computer network 150 can comprise various types of networks that enable the communication and exchange of information among the information handling systems. These network types include, but are not limited to, Local Area Networks (LANs), Wireless Local Area Networks (WLANs), home area networks (HAN), wide area networks (WAN), backbone networks (BBN), peer-to-peer networks (P2P), campus networks, enterprise networks, the Internet, single tenant or multi-tenant cloud computing networks, the Public Switched Telephone Network (PSTN), and any other network or network topology known by a person skilled in the art for interconnecting the systems 100.

FIG. 2 including FIG. 2A and FIG. 2B depicts a flow diagram of the method for determining effect of promoters and detractors on net customer acquisition, in accordance with exemplary embodiment. Computer-implemented method 200 including method 200A from FIG. 2A and method 200B from FIG. 2B comprising:
Step 201: conducting an enhanced net promoter score survey for capturing the referral disposition of a respondent by receiving an input related to recommendations or positive feedback given to others, positive feedback received from others, negative feedback given, the number of people to whom such negative feedback was given, and negative feedback or communication received from others by a respondent;
Step 202: converting the responses received from an enhanced net promoter score survey to compute an impact of promoters and detractors on the net customer acquisition;
Step 203: calculating the net promoter score (NPS) by subtracting the percentage of detractors from the percentage of promoters;
Step 204: assessing a referral disposition index to describe a respondent disposition to positively refer and influence a purchase or negatively refer and discourage the purchase of a product;
Step 205: evaluating a referral impact by multiplying the percentage of respondents who positively referred the product to others with the percentage of respondents who received a positive reference of the product from others;
Step 206: calculating the number of referrals per customer acquisition as the inverse of the referral impact;
Step 207: quantifying a referral impact of promoters by multiplying the referral impact with the percentage of promoters who positively referred the product to others;
Step 208: calculating the number of promoter referrals per customer acquisition as the inverse of the referral impact of promoters;
Step 209: determining an average number of people discouraged by dividing the total number of people who were discouraged or received a negative reference of the product from others by the total number of respondents;
Step 210: calculating an impact of discouragement by multiplying the percentage of respondents who discouraged others from purchasing the product with the percentage of respondents who received negative references of the product from others multiplied by the average number of people discouraged;
Step 211: calculating the number of discouragements per customer churn as the inverse of the discouragement impact;
Step 212: measuring a discouragement impact of detractors by multiplying the impact of discouragement with the percentage of detractors who negatively referred the product to others;
Step 213: calculating the number of detractor discouragements per customer churn as the inverse of the discouragement impact of detractors;
Step 214: computing a net addition to a customer base by dividing the total number of promoters by the number of promoter referrals per customer acquisition and then subtracting the total number of detractors divided by the number of detractor discouragements per customer churn;
Step 215: computing a net addition as a percentage of the existing customer base by dividing the net addition to the customer base by the total number of respondents;
Steps 216 and 217 are optional and to be performed if weighted averages and customer groups are to be used for calculating the net addition to the customer base:
Step 216: calculating the net addition to the customer base using weighted averages for different customer groups, defining the customer groups and weightages for each customer group, and calculating the weighted net addition to customer base for each customer group; and
Step 217: computing a net addition aggregate across all customer groups and a net addition aggregate as a percentage of the existing customer base.

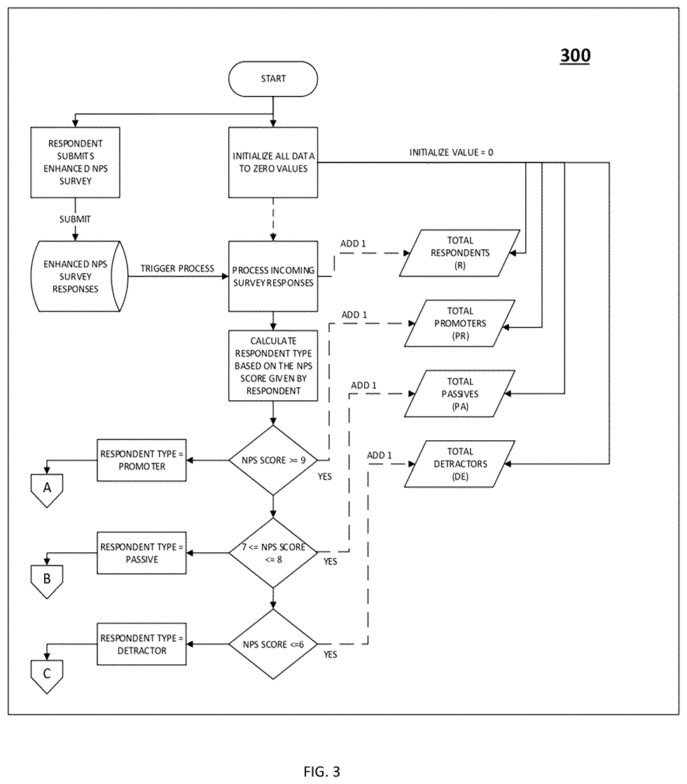

FIG. 3 depicts a flow diagram of a method 300 for determination of respondent type based on a response level NPS score. Initially, all data is initialized to zero values. Subsequently, when a respondent submits an enhanced net promoter score survey, the incoming responses are processed. The respondent type is then determined based on the net promoter score given by the respondent to the NPS question “On a scale of 0 to 10, how likely are you to recommend [company/product/service] to a friend or colleague?”. If the net promoter score given by the respondent is 9 or 10, the respondent type is classified as a promoter. If the net promoter score is 7 or 8, the respondent type is classified as passive. Lastly, if the net promoter score is equal to or less than 6, the respondent type is classified as a detractor.

The enhanced net promoter score survey includes descriptive questions that include, but not limited to, the following questions. The questions listed below may be worded or paraphrased in different ways with different choices of words, or there may be additional questions not explicitly listed below.

Question 1: Based on your experiences, how likely are you to recommend brand [company/product/service] “ABC” to your family, friends or colleagues (on a 0 to 10 scale);

Question 2: Please tell us why?

Question 3: Have you given positive feedback and referred “ABC” to someone in the past “Y” months? (Yes/No response);

Question 4: Have any of your friends/family/colleagues said positive words to you and referred “ABC” to you in the past “Y” months? (Yes/No response)

Question 5: Have you spoken negatively or discouraged someone from buying “ABC” in the past “Y” months? (Yes/No response)

Question 6: If “Yes” to question 5, how many people did you give negative feedback/discouraged? (Integer response to indicate the number of people), and

Question 7: Has anyone in the past “Y” months, spoken negatively or discouraged you about “ABC”? (Yes/No response).

The above questions 3 thru 7 may be worded in various different ways, but the essence of the invention is to capture the responses of the respondents for each of the aspects defined by the questions 3 and 7. In the above questions, there is addition of a dimension of time by asking the questions in relation to a pre-defined time-period of Y months to refer to the “recent past”, so that questions 3 thru 7 do not become completely open ended and are not interpreted as if the time period is ambiguous or as if the question pertains to all times.

The pre-defined time-period of Y months may be defined at the time of the enhanced net promoter survey design. For example, in one survey, the time-period is 6 months, and in another survey the time period is 12 months. The time-period depends on the survey and the type of market/category, and in general, decided based on business inputs and priorities.

The question 1 of the standard net promoter score survey measures the “word of mouth” or “intention to refer” by the respondent. The underlying assumption is that promoters are more likely to refer a product or brand positively, passives are less likely than promoters but more likely than detractors to refer a product or brand positively, whereas detractors are more likely to refer a product or brand negatively. Further, the respondents who say they are likely to recommend (based on the net promoter score they give in question 1) may not actually recommend the product or brand. Thus, the present invention captures that actual respondent behaviour within the net promoter score survey by asking the question 3 thru question 7 in addition to the net promoter score question for analysing if a customer has a positive referral disposition index or a negative referral disposition index.

The referral disposition index is a metric that explains a respondent's or customer's disposition to positively refer and influence the purchase or discourage the purchase of a brand or product or service.

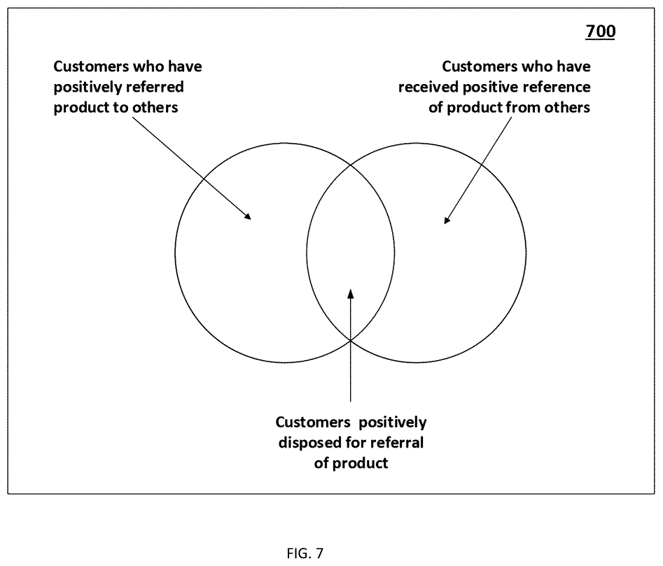

The respondents who have given positive feedback and referred “ABC” to others in the recent past, as indicated by a response of Yes to question 3 and have received a positive reference of “ABC” from their contacts like friends and family in the recent past, as indicated by a response of Yes to question 4, are more likely to be positively disposed to refer ABC positively in the future. Further, the positive referral disposition index 700 is depicted in FIG. 7.

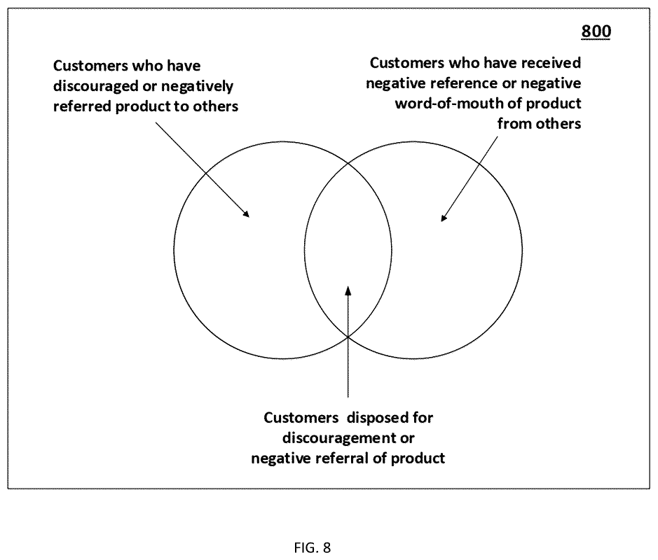

The respondents who have given negative feedback about or discouraged others from buying “ABC” to others in the recent past, as indicated by a response of Yes to question 5 and have received a negative reference of “ABC” from their friends and family in the recent past, as indicated by a response of Yes to question 7, are more likely to be negatively disposed to refer ABC in the near future. Further, the negative referral disposition index 800 is depicted in FIG. 8.

If a respondent indicates in question 5 that they have given negative feedback about or discouraged others from buying “ABC” to others in the recent past, then in question 6, further the respondent is asked to indicate how many people (as an integer count) they actually gave negative feedback about or discouraged from buying “ABC” in the recent past.

If a respondent answers a “No” to question 5, meaning that they have not given any negative feedback about “ABC” in the recent past, then the answer to question 6 is assumed to be a zero (0).

Once the referral disposition indices are calculated for the overall survey respondents, further the system 100 determines the referral disposition of promoters and detractors in the context of the net promoter score response.

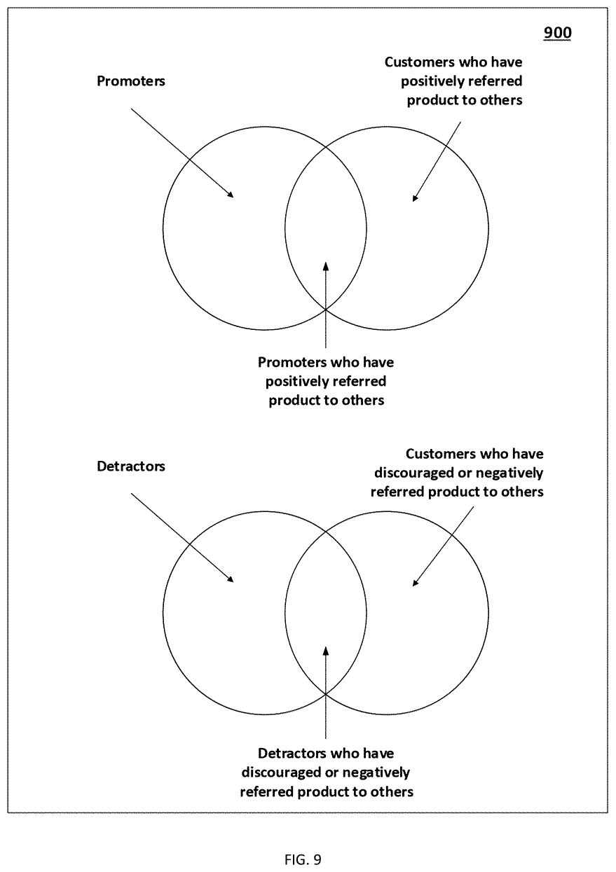

If a respondent has given a net promoter score of 9 or 10 in question 1, they are classified as a promoter. If the same respondent (promoter) has given positive feedback and referred “ABC” to others in the recent past, as indicated by a response of Yes to question 3, then the system 100 categorizes them as promoters who have positively referred and influenced the purchase of “ABC”. This is a subset of all the respondents who have positively referred “ABC” to others as depicted in 900 in FIG. 9.

If a respondent has given a net promoter score of 6 or lower in question 1, they are classified as a detractor. If the same respondent (detractor) has given negative feedback or discouraged others from buying “ABC” in the recent past, as indicated by a response of Yes to question 5, then the system 100 categorizes them as detractors who have negatively referred and discouraged the purchase of “ABC”. This is a subset of all the respondents who have negatively referred “ABC” as depicted in 900 in FIG. 9.

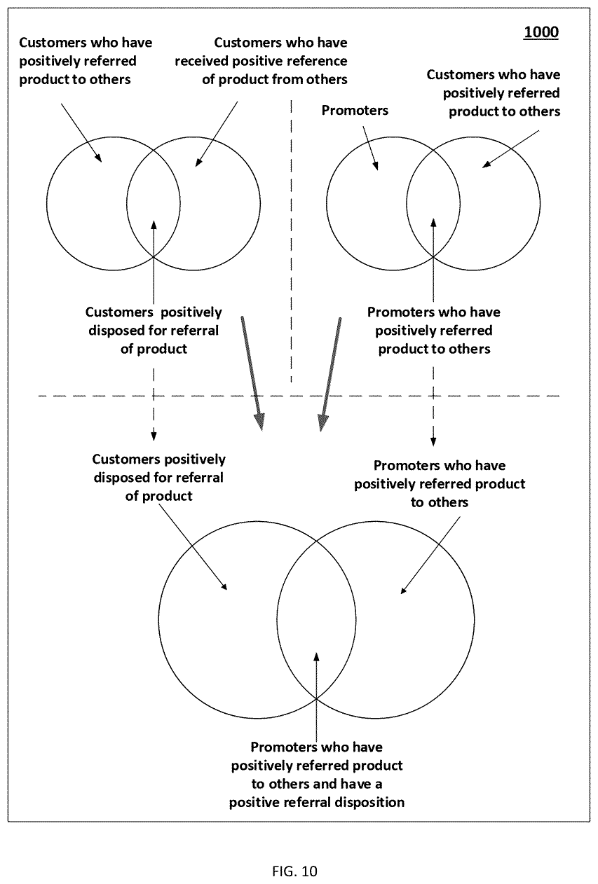

Based on the positive referral disposition index 700 in FIG. 7, system 100 determines the set of customers who are positively disposed for referral of the product “ABC”. From 900 in FIG. 9, system 100 determines the set of promoters who have positively referred to and influenced the purchase of “ABC”. From these two sets, system 100 determines the set of promoters who have positively referred to and influenced the purchase of “ABC” and who have a positive referral disposition, as depicted in 1000 in FIG. 10.

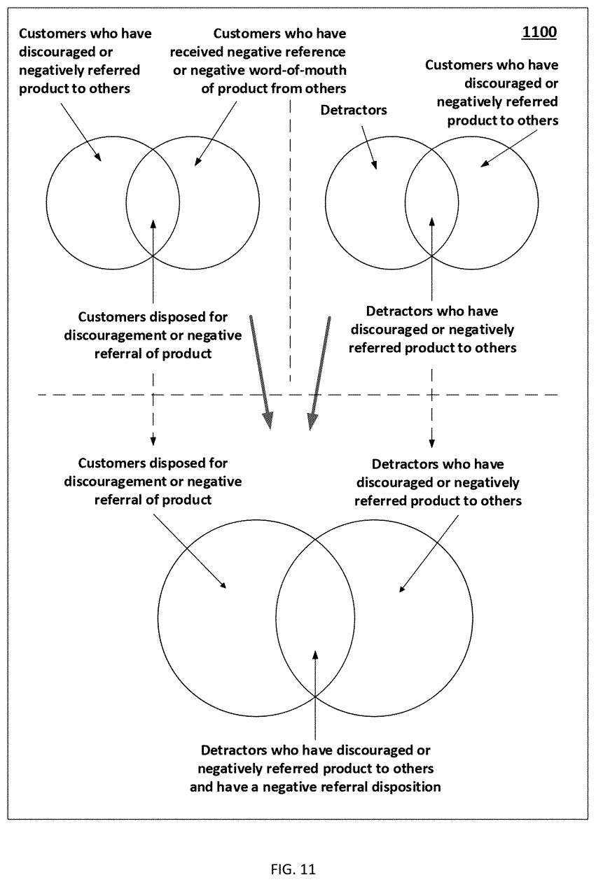

Based on the negative referral disposition index 800 in FIG. 8, system 100 determines the set of customers who are disposed for discouragement or negative referral of the product “ABC”. From 900 in FIG. 9, system 100 determines the set of detractors who have discouraged or negatively referred the product “ABC” to others. From these two sets, system 100 determines the set of detractors who have discouraged or negatively referred to the product “ABC” and who have a negative referral disposition, as depicted in 1100 in FIG. 11.

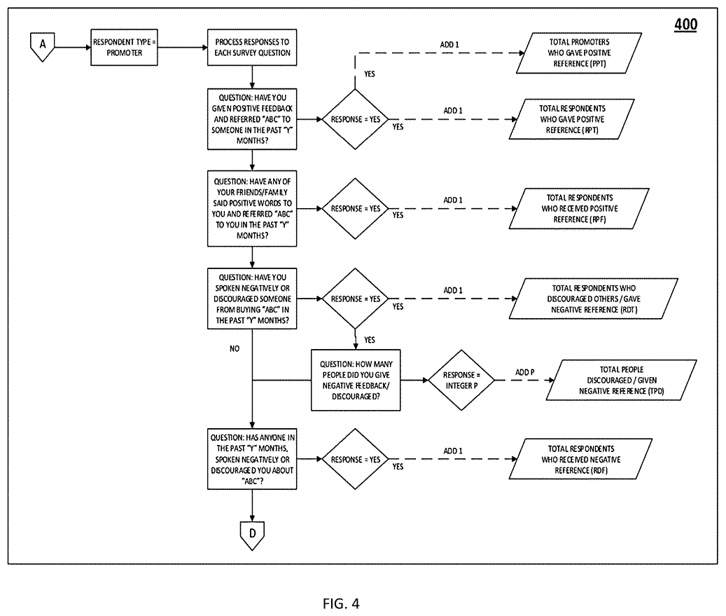

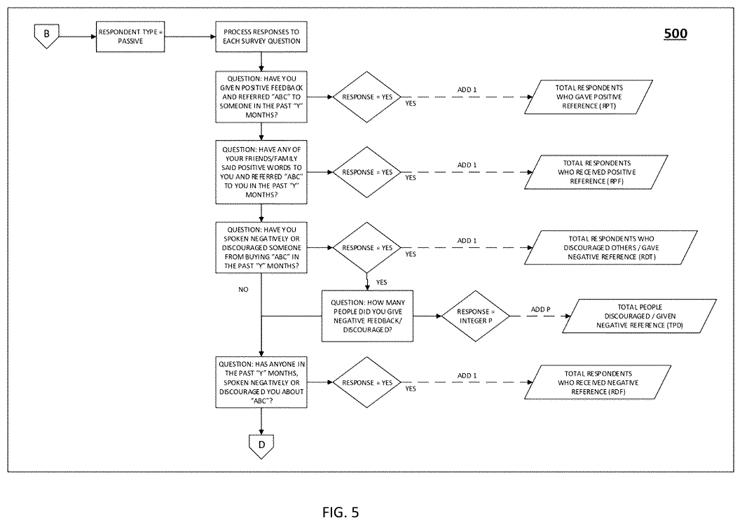

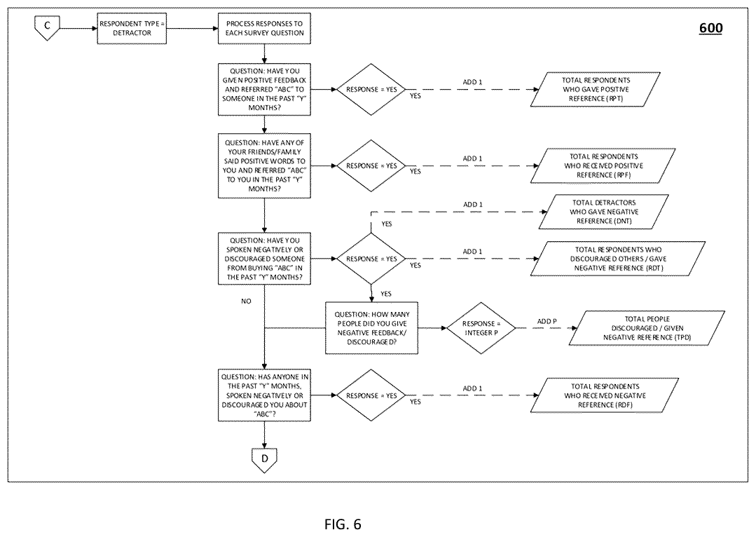

Further, the flowcharts of methods for processing the enhanced survey responses for respondent type as promoter (400), passive (500) and detractor (600) are depicted in FIG. 4, FIG. 5 and FIG. 6.

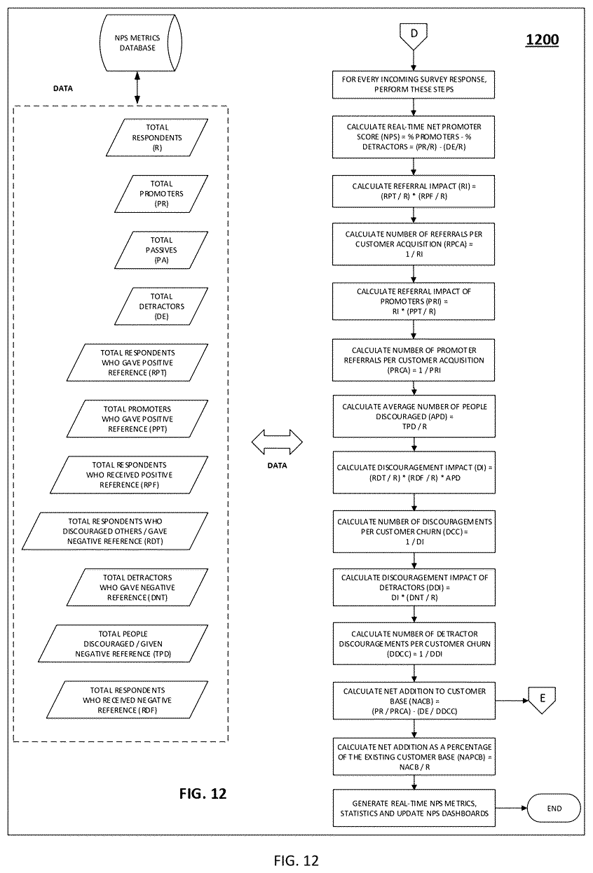

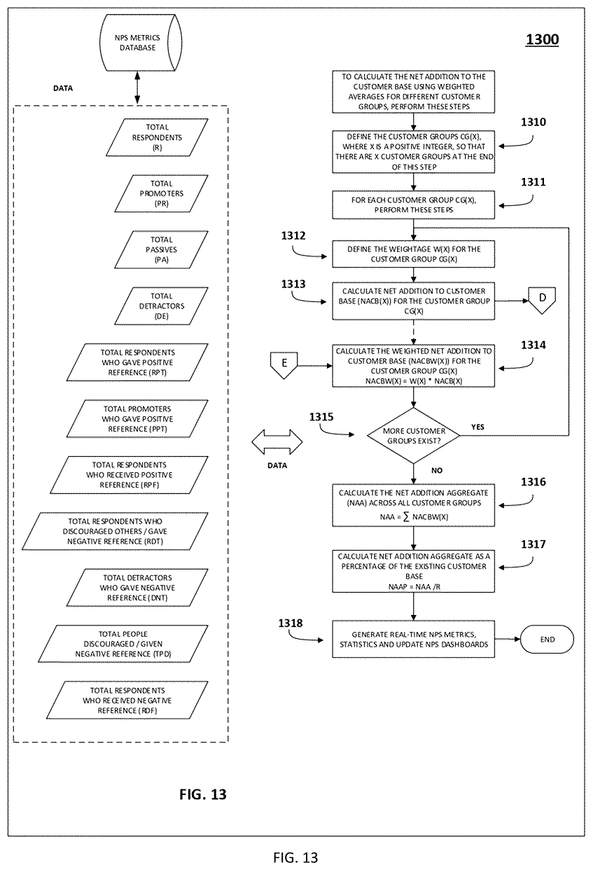

The following data variables are referenced in methods 300 in FIG. 3, 400 in FIG. 4, 500 in FIG. 5, 600 in FIG. 6, 1200 in FIGS. 12 and 1300 in FIG. 13. All data is initialized to zero at the beginning of method 300 in FIG. 3.
(a) Total number of respondents (R)
(b) Total number of promoters (PR)
(c) Total number of passives (PA)
(d) Total number of detractors (DE)
(e) Total respondents who gave positive reference (RPT)
(f) Total promoters who gave positive reference (PPT)
(g) Total respondents who received positive reference (RPF)
(h) Total respondents who discouraged or gave negative reference (RDT)
(i) Total detractors who gave negative reference (DNT)
(j) Total people discouraged (TPD)
(k) Total respondents who received negative reference (RDF)

In method 300 in FIG. 3, if the respondent type is determined to be a promoter, method 400 in FIG. 4 is used to process the responses to questions 3, 4, 5, 6 and 7. If the response to question 3 is Yes, a quantity of one (1) is added to the data variables RPT and PPT so that the count of total respondents who gave positive reference (RPT) and total respondents who gave positive reference (PPT) is increased by 1 each. If the response to question 4 is Yes, a quantity of one (1) is added to the data variable RPF so that the count of total respondents who received positive reference (RPF) is increased by 1. If the response to question 5 is Yes, a quantity of one (1) is added to the data variable RDT so that the count of total respondents who discouraged or gave negative reference (RDT) is increased by 1. If the response to question 5 is Yes, the response to question 6 is processed and the count P of people discouraged in the response to question 6 is added to the data variable TPD so that the count of total people discouraged (TPD) is increased by P. If the response to question 5 is No, the response to question 6 is ignored and the count P is assumed to be zero (0). If the response to question 7 is Yes, a quantity of one (1) is added to the data variable RDF so that the count of total respondents who received negative reference (RDF) is increased by 1.

In method 300 in FIG. 3, if the respondent type is determined to be a passive, method 500 in FIG. 5 is used to process the responses to questions 3, 4, 5, 6 and 7. If the response to question 3 is Yes, a quantity of one (1) is added to the data variable RPT so that the count of total respondents who gave positive reference (RPT) is increased by 1. If the response to question 4 is Yes, a quantity of one (1) is added to the data variable RPF so that the count of total respondents who received positive reference (RPF) is increased by 1. If the response to question 5 is Yes, a quantity of one (1) is added to the data variable RDT so that the count of total respondents who discouraged or gave negative reference (RDT) is increased by 1. If the response to question 5 is Yes, the response to question 6 is processed and the count P of people discouraged in the response to question 6 is added to the data variable TPD so that the count of total people discouraged (TPD) is increased by P. If the response to question 5 is No, the response to question 6 is ignored and the count P is assumed to be zero (0). If the response to question 7 is Yes, a quantity of one (1) is added to the data variable RDF so that the count of total respondents who received negative reference (RDF) is increased by 1.

In method 300 in FIG. 3, if the respondent type is determined to be a detractor, method 600 in FIG. 6 is used to process the responses to questions 3, 4, 5, 6 and 7. If the response to question 3 is Yes, a quantity of one (1) is added to the data variable RPT so that the count of total respondents who gave positive reference (RPT) is increased by 1. If the response to question 4 is Yes, a quantity of one (1) is added to the data variable RPF so that the count of total respondents who received positive reference (RPF) is increased by 1. If the response to question 5 is Yes, a quantity of one (1) is added to the data variables RDT and DNT so that the count of total respondents who discouraged or gave negative reference (RDT) and total detractors who gave negative reference (DNT) is increased by 1 each. If the response to question 5 is Yes, the response to question 6 is processed and the count P of people discouraged in the response to question 6 is added to the data variable TPD so that the count of total people discouraged (TPD) is increased by P. If the response to question 5 is No, the response to question 6 is ignored and the count P is assumed to be zero (0). If the response to question 7 is Yes, a quantity of one (1) is added to the data variable RDF so that the count of total respondents who received negative reference (RDF) is increased by 1.

Once the responses are processed as per methods 300 in FIG. 3, 400 in FIG. 4, 500 in FIGS. 5 and 600 in FIG. 6, the workflow proceeds to method 1200 in FIG. 12.

The steps in method 1200 in FIG. 12 and the equivalent steps in method 200 in FIG. 2A and FIG. 2B involve several calculations that are performed by the system 100 based on the equations defined below.

$$\begin{matrix}( 1 ) & \\ Referral Impact ( RI ) = Percentage of Respondents who positively referred the product to others * Percentage of Respondents who received a positive reference of the product from others = ( RPT / R ) * ( RPF / R ) & [ Equation 1 ]\end{matrix}$$

$$\begin{matrix}( 2 ) & \\ Referrals Per Customer Acquisition ( RPCA ) = Number of referrals required to acquire 1 customer = ( 1 / RI ) & [ Equation 2 ]\end{matrix}$$

$$\begin{matrix}( 3 ) & \\ Referral Impact of Promoters ( PRI ) = Referral Impact * Percentage of Promoters who positively referred the product to others = RI * ( PPT / R ) & [ Equation 3 ]\end{matrix}$$

$$\begin{matrix}( 4 ) & \\ Promoter Referrals Per Customer Acquisition ( PRCA ) = Number of promoters required to acquire 1 customer = ( 1 / PRI ) & [ Equation 4 ]\end{matrix}$$

$$\begin{matrix}( 5 ) & \\ Average Number of People Discouraged ( APD ) = Total Number of People Discouraged / Total Respondents = ( TPD / R ) & [ Equation 5 ]\end{matrix}$$

$$\begin{matrix}( 6 ) & \\ Discouragement Impact ( DI ) = Percentage of Respondents who discouraged others from purchasing the product * Percentage of Respondents who received a negative reference of the product from others * Average Number of People Discouraged = ( ( RDT / R ) * ( RDF / R ) * APD ) & [ Equation 6 ]\end{matrix}$$

$$\begin{matrix}( 7 ) & \\ Discouragements Per Customer Churn ( DCC ) = Number of discouragements leading to 1 lost customer = ( 1 / DI ) & [ Equation 7 ]\end{matrix}$$

$$\begin{matrix}( 8 ) & \\ Discouragement Impact of Detractors ( DDI ) = Discouragement Impact * Percentage of Detractors who gave a negative reference of the product to others = ( DI * ( DNT / R ) ) & [ Equation 8 ]\end{matrix}$$

$$\begin{matrix}( 9 ) & \\ Detractor Discouragements Per Customer Churn ( DDCC ) = Number of detractors leading to 1 lost customer = ( 1 / DDI ) & [ Equation 9 ]\end{matrix}$$

$$\begin{matrix}( 10 ) & \\ Net Addition to Customer Base ( NACB ) = Number of customers added - Number of customers lost = ( PR * PRI ) - ( DE * DDI ) = ( PR / PRCA ) - ( DE / DDCC ) & [ Equation 10 ]\end{matrix}$$

$$\begin{matrix}( 11 ) & \\ Net Addition as a Percentage of Existing Customer Base ( NAPCB ) = ( NACB / R ) & [ Equation 11 ]\end{matrix}$$

Thus, the method 1200 in FIG. 12 can be used to calculate the Net Customer Acquisition which is obtained by subtracting the total customer lost from the total customers gained or added during a time period. This can be calculated using Equation 11, Net Addition to Customer Base (NACB).

Net Customer Acquisition as a percentage of the existing customer base is useful in determining the relative growth of the customer base as compared to a baseline. This can be calculated using Equation 11 by dividing the Net Addition to Customer Base (NACB) by the total number of respondents.

The overall method being proposed in our invention for determining the effect of promoters and detractors on net customer acquisition through methods 300 in FIG. 3, 400 in FIG. 4, 500 in FIGS. 5 and 600 in FIGS. 6, and 1200 in FIG. 12, can be illustrated as an example with sample data as given below.

Assume the following data as responses from the enhanced net promoter score survey for the purposes of the sample illustration:
(a) Total number of respondents (R)=100
(b) Number of respondents who positively referred “ABC” to others (RPT)=70
(c) Number of respondents who received positive references of “ABC” from others (RPF)=40
(d) Number of promoters who positively referred “ABC” to others (PPT)=50
(e) Number of respondents who discouraged others from buying “ABC” (RDT)=50
(f) Number of respondents who received negative references of “ABC” from others (RDF)=40
(g) Total People Discouraged (TPD)=400
(h) Number of detractors who negatively referred “ABC” to others (DNT)=30

Based on the above sample data, system 100 will calculate the referral impact of promoters as per method 1200 in FIG. 12.

$$\begin{matrix}( i ) & \\ Referral Impact ( RI ) = ( RPT / R ) * ( RPF / R ) = 0.7 * 0.4 = 0.28 = 28 \% & ( from Equation 1 )\end{matrix}$$

$$\begin{matrix}( j ) & \\ Referrals Per Customer Acquisition ( RPCA ) = 1 / RI = 1 / 0.28 = 3.57 ∼ 4 & ( from Equation 2 )\end{matrix}$$

$$\begin{matrix}( k ) & \\ Referral Impact of Promoters ( PRI ) = RI * ( PPT / R ) = 0.28 * 0.5 = 0.14 = 14 \% & ( from Equation 3 )\end{matrix}$$

$$\begin{matrix}( l ) & \\ Promoter Referrals Per Customer Acquisition ( PRCA ) = Number of promoters required to acquire 1 customer = 1 / PRI = 1 / 0.14 = 7.14 ∼ ∼ 7 & ( from Equation 4 )\end{matrix}$$

$$\begin{matrix}( m ) & \\ Average number of People Discouraged ( APD ) = ( TPD / R ) = 400 / 100 = 4 & ( from Equation 5 )\end{matrix}$$

$$\begin{matrix}( n ) & \\ Discouragement Impact ( DI ) = ( ( RDT / R ) * ( RDF / R ) * APD ) = 0.5 * 0.4 * 4 = 0.8 = 80 \% & ( from Equation 6 )\end{matrix}$$

$$\begin{matrix}( o ) & \\ Discouragements Per Customer Churn ( DCC ) = ( 1 / DI ) = 1 / 0.8 = 1.25 ∼ ∼ 2 & ( from Equation 7 )\end{matrix}$$

$$\begin{matrix}( p ) & \\ Discouragement Impact of Detractors ( DDI ) = ( DI * ( DNT / R ) ) = 0.8 * 0.3 = 0.24 = 24 \% & ( from Equation 8 )\end{matrix}$$

$$\begin{matrix}( q ) & \\ Detractor Discouragements Per Customer Churn ( DDCC ) = Number of detractors leading to 1 lost customer = ( 1 / DDI ) = 1 / 0.24 = 4.16667 ∼ ∼ 4 & ( from Equation 9 )\end{matrix}$$

From the above example, system 100 can determine that (A) seven (7) promoters are required to acquire 1 new customer and (B) four (4) detractors can lead to 1 lost customer/1 churn.

Based on this, the net effect on customer acquisition can be calculated by system 100 as follows.

Assume that a company conducts an enhanced net promoter score survey and gets a net promoter score of 40 (with total respondents R=500, promoters PR=300, detractors DE=100, passives PA=100).

$$Net Promoter Score ( NPS ) = \% promoters - \% detractors = 60 - 20 = 40$$

Promoter Referrals Per Customer Acquisition (PRCA)=7 (as calculated in (I) above).

Detractor Discouragements Per Customer Churn (DDCC)=4 (as calculated in (q) above).

$$Net Addition to Customer Base ( NACB ) = Number of customers added - Number of customers lost = ( PR / PRCA ) - ( DE / DDCC ) = ( 300 / 7 ) - ( 100 / 4 ) ∼ ∼ 43 - 25 = 18 \qquad ( from Equation 10 )$$

$$Net addition as a Percentage of the Existing Customer Base ( NAPCB ) = NACB / R = 18 / 500 = 3.6 \% \qquad ( from Equation 11 )$$

Further, based on these calculations from the sample enhanced net promoter score survey results, the company conducting the survey knows that with a NPS of 40, the net addition to customer base is 3.6%. Based on this, the company can simulate various scenarios. For example, taking the above case, a manager at the company might want to know what would happen, if the number of Promoters went up by 50 and the number of detractors went down by 50. So now in this simulation, we have the following data:

Total respondents R=500, Promoters PR=350, Detractors DE=50, passives PA=100.

$$NPS = \% promoters - \% detractors = 70 - 10 = 60$$

$$Net addition to customer base NACB = ( PR / PRCA ) - ( DE / DDCC ) = ( 350 / 7 ) - ( 50 / 4 ) ∼ ∼ 50 - 13 = 37 \qquad ( from Equation 10 )$$

$$Net addition as a percentage of the existing customer base ( NAPCB ) = NACB / R = 37 / 500 = 7.4 \% \qquad ( from Equation 11 )$$

Thus, from this simulation, as the net promoter score goes up to 60, the net customer additions go up from 3.6% to 7.4%, which gives the company and its stakeholders a confidence that improving the net promoter score does indeed make a difference to their business.

The present invention is used to support simulation of various scenarios to determine the impact of improvements in net promoter score to net customer acquisition. Further the present invention also supports updating all the calculations and metrics in real time i.e., with every new response received for an enhanced net promoter survey and the present invention is able to determine the promoter impact, detractor impact and the effect on net customer acquisition.

Further, it is assumed that each response (i.e. the survey response from each respondent) carries the same weight, similar to how the standard net promoter score method treats all responses as having equivalent weightage and it is crucial to extend the invention to attach different weights for the responses from different types of respondents, within the realm of known statistical techniques, which makes the present invention more reflective of the reality.

The present invention can be used for calculating the net addition to customer base using weighted averages for different customer groups.

Computer-implemented method 1300 in FIG. 13 provides the steps for calculating the net addition to customer base using weighted averages for different customer groups in accordance with an exemplary embodiment, comprising:
Step 1310: defining the different customer groups such that there are more than one (1) customer groups;
Step 1311: for each customer group CG(x), performing steps 1312 through 1315;
Step 1312: defining the weightage W(x) for the customer group CG(x)

Step 1313: calculating the net addition to customer base NACB(x) for the customer group CG(x) as per method 1200 in FIG. 12;
Step 1314: calculating the weighted net addition to customer base NACBW(x) for the customer group CG(x) as per Equation 12;
Step 1315: checking if there are more customer groups in the list and if yes performing steps 1312 through 1315 for the next customer group;
Step 1316: calculating the net addition aggregate NAA across all customer groups CG(x) as per Equation 13;
Step 1317: calculating the net addition aggregate as a percentage of the existing customer base NAAP as per Equation 14;
Step 1318: calculating and generating real-time metrics, statistics and updating dashboards;
For calculating the net addition aggregate, the following equations are defined:

$$Weighted Net Addition to Customer Base for the customer group CG ( x ) ( NACBW ( x ) ) = W ( x ) * NACB ( x ) , where W ( x ) is the weightage for the customer group CG ( x ) and NACB ( x ) is the net addition to customer base for the customer group CG ( x ) \qquad ( Equation 12 )$$

$$Net Addition Aggregate across all customer groups CG ( x ) ( NAA ) = \sum NACBW ( x ) = \sum W ( x ) * NACB ( x ) \qquad ( Equation 13 )$$

$$Net Addition Aggregate as a percentage of the existing customer base ( NAAP ) = NAA / R \qquad ( Equation 14 )$$

This method 1300 in FIG. 13 can be illustrated through an example using a well-known standard metric such as Average Revenue Per User (ARPU).

Organizations have customers of varying contribution to their revenues. Average Revenue Per User (ARPU) is one of the standard industry metrics for determining how valuable a customer is (to the organization) based on the average revenue that they contribute for a pre-defined period (such as per month or per year).

In one such example, let us assume that all the customers of the organization are clubbed into 3 groups i.e., High Value customers (H), Medium Value customers (M) and Low Value customers (L), corresponding to a high ARPU, medium ARPU and low ARPU value.

Further, a plurality of weightages can be attached to the input received from the different groups of customers. For example, the weightages are WH (for high value customers), WM (for medium value customers) and WL (for low value customers).

For example, the responses of high value customers could have a weightage of WH=0.6 (assuming 60% of revenues is contributed by this group) as compared to the responses of medium value customers and low value customers that can have weightages of WM=0.3 and WL=0.1 respectively, since the contribution of these groups to the overall revenue is assumed 30% and 10% respectively.

Further, the data processing module 104 calculates a net addition of customers for each of the high, medium and low value customer groups, Net Addition by High (NACBH), Net Addition by Medium (NACBM) and Net Addition by Low (NACBL).

Furthermore, the data processing module 104 calculates the overall net addition by using the defined weights, Net Addition Aggregate, NAA=WH*NACBH+WM*NACBM+WL*NACBL (from Equation 13)

The NAA is divided by the total number of respondents to calculate the Net Addition Aggregate as a percentage of the existing customer base NAAP=NAA/R (from Equation 14)

The present invention may be a system, a method, and/or a computer program product at any possible technical detail level of integration. The computer program product may include a computer-readable storage medium (or media) having the computer-readable program instructions thereon for causing the one or more hardware processor to carry out aspects of the present invention.

Therefore, the present invention provides a system and method for determining effect of promoters and detractors on net customer acquisition and represents a significant change and improvement over the known net promoter score technique and easily implemented using existing technologies and programming methods to build software applications, further the present invention creates a new perspective of current referral disposition to predict acquisition or churn of customers rather than past claimed behavior. Additionally, the present invention helps build credibility and assists the management and stakeholders in the organization.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include modules that perform certain tasks. The modules discussed herein may include script, batch, or other executable files. The modules may be stored on a machine-readable or computer readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removable or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a module for calling sub-modules may be decomposed so that each sub-module performs its function and passes control directly to another sub-module.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A system for determining effect of promoters and detractors on net customer acquisition, the system comprising of:
one or more hardware processors;
a memory coupled to the one or more hardware processors, wherein the memory comprise a plurality of modules in the form of programmable instructions executable by the one or more hardware processors; and
wherein the plurality of modules comprise:
a data acquisition module configured to conduct an enhanced net promoter score survey for capturing a referral disposition of a respondent by receiving an input related to recommendations or positive feedback given to others, positive feedback received from others, negative feedback given to others, the number of people to whom such negative feedback was given and negative feedback or communication received from others by a respondent;
a data processing module configured to convert a response received from the enhanced net promoter score survey to compute the impact of promoters and detractors on the net customer acquisition;
assessing a net promoter score rating provided by an individual respondent to classify the individual respondent into one of the categories of promoters, passives, or detractors, and calculating the net promoter score by subtracting a percentage of detractors from a percentage of promoters;
assessing a referral disposition index for describing a respondent disposition to positively refer and influence a purchase or negatively refer and discourage the purchase of a product;
evaluating a referral impact by multiplying the percentages of respondents who positively referred the product to others with the percentage of respondents who received a positive reference of the product from others;
calculating a number of referrals per customer acquisition as the inverse of the referral impact;
multiplying the referral impact with the percentage of promoters who positively referred the product to others for obtaining a referral impact of promoters;
calculating a number of promoter referrals per customer acquisition as the inverse of the referral impact of promoters;
determining an average number of people discouraged by dividing the total number of people who were discouraged or received a negative reference of the product from the respondents by the total number of respondents;
calculating an impact of discouragement by multiplying the percentage of respondents who discouraged others from purchasing the product with the percentage of respondents who received negative references of the product from others multiplied by the average number of people discouraged;
calculating a number of discouragements per customer churn as the inverse of the discouragement impact;
measuring the discouragement impact of detractors by multiplying the impact of discouragement with the percentage of detractors who negatively referred the product to others;
calculating the number of detractor discouragements per customer churn as the inverse of the discouragement impact of detractors;
computing a net addition to a customer base by dividing the total number of promoters by the number of promoter referrals per customer acquisition and then subtracting the total number of detractors divided by the number of detractor discouragements per customer churn;
evaluating a net addition as a percentage of the existing customer base is calculated by dividing a net addition to customer base with the total number of respondents;
determining a net addition of each customer group by their assigned weights and adding them together to obtain a net addition aggregate; and
dividing the net addition aggregate by the total number of respondents for obtaining net customer addition aggregate in terms of percentage of the existing customer base.

2. The system of claim 1, wherein the data acquisition module includes scanner, keyboard, microphone, mouse and touchpad.

3. The system of claim 1, wherein the system further comprise of an input means for receiving an input data and a data storage unit for storing incoming input data or having a pre-stored data.

4. The system of claim 1, wherein the enhanced net promoter score survey comprise of a set of questions for the respondent.

5. The system of claim 1, wherein the enhanced net promoter score survey assists in measuring an intention to refer, a positive referral disposition index, a negative referral disposition index.

6. The system of claim 1, wherein the data acquisition module transfers the response from the respondent to the data processing module.

7. The system of claim 1, wherein the data processing module refers to central processing unit.

8. The system of claim 1, wherein the referral disposition index is a metric which describes the respondent disposition.

9. The system of claim 1, wherein the revenue contribution value of a customer is calculated according to high value customer, medium value customer and low value customer corresponding to a high revenue contribution, medium revenue contribution and a low revenue contribution.

10. The system of claim 1, wherein the customer group includes but not limited to high, medium and low value customers.

11. The system of claim 1, wherein the product includes brand or service.

12. A computer-implemented method comprising:
conducting an enhanced net promoter score survey for capturing a referral disposition of a respondent by receiving an input related to recommendations or positive feedback given to others, positive feedback received from others, negative feedback given to others, the number of people to whom such negative feedback was given and negative feedback or communication received from others by a respondent;
converting a response received from the enhanced net promoter score survey to compute an impact of promoters and detractors on the net customer acquisition;
assessing the net promoter score rating provided by an individual respondent to classify the individual respondent into one of the categories of promoters, passives or detractors and calculating the net promoter score by subtracting the percentage of detractors from the percentage of promoters;
assessing a referral disposition index to describe a respondent disposition to positively refer and influence a purchase or negatively refer and discourage the purchase of a product;
evaluating a referral impact by multiplying the percentage of respondents who positively referred the product to others with the percentage of respondents who received a positive reference of the product from others;
calculating the number of referrals per customer acquisition as the inverse of the referral impact;
quantifying a referral impact of promoters by multiplying the referral impact with the percentage of promoters who positively referred the product to others;
calculating the number of promoter referrals per customer acquisition as the inverse of the referral impact of promoters;
determining an average number of people discouraged by dividing the total number of people who were discouraged or received a negative reference of the product from the respondents by the total number of respondents;
calculating an impact of discouragement by multiplying the percentage of respondents who discouraged others from purchasing the product with the percentage of respondents who received negative references of the product from others multiplied by the average number of people discouraged;
calculating a number of discouragements per customer churn as the inverse of the discouragement impact;
measuring a discouragement impact of detractors by multiplying the impact of discouragement with the percentage of detractors who negatively referred the product to others;
calculating the number of detractor discouragements per customer churn as the inverse of the discouragement impact of detractors,
computing a net addition to a customer base by dividing the total number of promoters by the number of promoter referrals per customer acquisition and then subtracting the total number of detractors divided by the number of detractor discouragements per customer churn;
calculating a net addition as a percentage of the existing customer base by dividing the net addition to customer base with the total number of respondents;
determining the net addition of each customer group by their assigned weights and adding them together to obtain a net addition aggregate; and
dividing the net addition aggregate by the total number of respondents for obtaining net customer addition aggregate in terms of percentage of the existing customer base.

13. The method of claim 12, wherein the enhanced net promoter score survey comprise of a set of questions for the respondent.

14. The method of claim 12, wherein the enhanced net promoter score survey assists in measuring an intention to refer, a positive referral disposition index, a negative referral disposition index.

15. The method of claim 12, wherein the referral disposition index is a metric which describes the respondent disposition.

16. The method of claim 12, wherein the revenue contribution value of a customer is calculated according to high value customer, medium value customer and low value customer corresponding to a high revenue contribution, medium revenue contribution and a low revenue contribution.

17. The method of claim 12, wherein the customer group includes but not limited to high, medium and low value customers.

18. The method of claim 12, wherein the product includes brand or service.
